(19) United States
(12) Patent Application Publication
(10) Pub. No.: US 2007/0108791 A1
(43) Pub. Date: May 17, 2007

(54) LIFTING DEVICE FOR A DISPLAY

(76) Inventor: Marek Okninski, New York, NY (US)

Correspondence Address: SUGHRUE MION, PLLC, 2100 PENNSYLVANIA AVENUE, N.W., SUITE 800, WASHINGTON, DC, 20037, US

(21) Appl. No.: 11/554,971

(22) Filed: Oct. 31, 2006

Related U.S. Application Data
(63) Continuation-in-part of application No. 10/428,674, filed on May 5, 2003, now Pat. No. 7,128,003.

(51) Int. Cl. B60J 3/00

(52) U.S. Cl. 296/97.12

(57) ABSTRACT

A device for lifting and lowering objects and electronic devices includes an elevating mechanism that elevates a first sliding frame and a second sliding frame. The first and second sliding frames move independently inside of a mounting frame. A linear actuator drives the first sliding frame and causes the first sliding frame to rise and fall. A belt and pulley configuration transfers an elevating force from the first sliding frame to the second sliding frame. The second or subsequent sliding frame is elevated to place the display or object at a desired height and may be retracted to conceal the display or object in a cabinet, or the like.

This is a Continuation-in-Part of application Ser. No. 10/428,674 filed may 5, 2003. The entire disclosure of the prior application, application Ser. No. 10/428,674 is hereby incorporated by reference.

### BACKGROUND OF THE INVENTION

1. Field of the Invention

The present invention relates to a device for lifting and lowering visual displays, such as television sets, video monitors, art pieces, flat plasma displays and the like.

2. Background of the Invention

The development of television technology has been very progressive, with television sets becoming very large and thin. The most recent aspect of this technology is thin, flat plasma TV displays. Since it is preferable to hide a display when not in use, there is a need for a lifting device, which would enclose a plasma display within any type of cabinet, and elevate the display above such cabinet. Existing devices are esthetically unsightly or impractical. For example, U.S. Design Pat. No. 6,494,150 provides a lift having a very heavy construction and does not provide a way of mounting the lift along its height. Since prior art lifts can only be attached at their base, they lack vertical stability and therefore are unlikely to be used successfully as a lift for a Plasma TV. Accordingly, a lift device is needed, which is compact, light, efficient, stable and safe.

### BRIEF SUMMARY OF THE INVENTION

An aspect of the invention is to provide a simple, practical and safe design, which can work with different types and sizes of plasma displays. An embodiment of the present invention includes a sliding frame within a frame construction, where two frames slide independently inside or outside a third fixed frame.

An illustrative embodiment of the invention is designed to be light and compact. For example, it is possible to make the lift as thin as 1¾″ for lower weight visual displays and 2¼″ thick for heavy weight visual displays. A plasma TV or visual display may be mounted to the lift by two horizontally placed display-supporting bars. A mounting height of the bars may be adjustable. In an exemplary embodiment, the lifting device itself is mounted along its full height, to a back panel (e.g., ¾″ Veneer Core Plywood), which replaces an original furniture back. This is done because in many cases, the back of the furniture is made out of ¼″ thick MDF or Flake Board, for example, which doesn't provide enough stability to support the weight of a lift and the display. A further aspect of the invention is an achievement of horizontal and vertical stability, which is lacking in the prior art. In an embodiment, the stability is achieved by mounting the lift directly to a vertical surface along its full height.

The present invention is also highly efficient. In an exemplary embodiment, a small dimensioned 24VDC right angle gear motor is used, which is hidden inside the lift's enclosure. High efficiency is further achieved with the use of ball bearing slides and Teflon based lead screw nuts. Lifting action is provided, for example, with a combination of ¾″ lead screws, chains or belts and pulleys or roller chain sprockets.

In an exemplary embodiment, a visual display comprises a mounting frame, a mounting frame and a plurality of movable frames comprising a first movable frame slidably engaged to the mounting frame; a second movable frame slidably engaged to the first movable frame; at least a third movable from slidably engaged with the second movable frame. A last of the plurality of movable frames is configured to support a display. At least one linear actuator engages the first movable frame to raise and lower the first movable frame, the linear actuator is disposed between the first movable frame and the mounting frame. At least a first pulley is attached to the first movable frame and at least one first pliable member engages the at least one first pulley. A side of the first pliable member is coupled to the mounting frame and another side of the pliable member is coupled with the second frame, such that the second movable frame moves at a greater rate than the first movable frame due to a mechanical advantage provided by the at least one pulley.

At least a second pulley is attached to the second movable frame and at least one second pliable member engages the at least one second pulley. A side of the first pliable member is coupled to the first movable frame and another side of the second pliable member is coupled with the third frame, such that the third frame moves at a greater rate than the second movable frame due to a mechanical advantage provided by the at least one second pulley.

The movable frames are disposed in relation to each other in one of a retracted configuration and an extended configuration, and at least a portion of the second movable frame extends vertically past a portion of the first movable frame, and at least a portion of the third movable frame extends vertically past a portion of the second movable frame.

In an exemplary embodiment, the linear actuator is positioned behind a backside of the visual display when the elevating apparatus is in the retracted configuration, such that a portion of the linear actuator is disposed at a height equal to a height of a portion of the visual display in a horizontal plane.

At least a portion of the plurality of movable frames may comprise a panel and ball bearings maybe provided between the first movable frame and the mounting frame.

The mounting frame comprises mounting brackets and slide members respectively attached to the mounting frame. A motor is attached to the linear actuator.

The plurality of movable frames are provided with at least one support member attached to the visual display. The at least one support member is operable to swivel. The support member may swivel by means of a rotary actuator. The rotary actuator may comprise a motor. A mounting panel may be attached to the mounting frame. The mounting panel may comprise a one piece element.

In an exemplary embodiment, the elevating apparatus has a front area where the display is located, and the linear actuator is positioned behind the front area, such that a portion of the linear actuator is disposed at a height equal to a height of a portion of the display in a horizontal plane the elevating apparatus is in the contracted configuration.

At least one motor that drives the at least one linear actuator to elevate the display to a desired height, and to lower the display. The at least one linear actuator may comprise a chain, belt, lead screw, ball screw, cable. The at least one linear actuator may also be spring driven, pneumatic, hydraulic, electro-hydraulic, or comprises a rack and pinion.

In an exemplary embodiment the visual display comprises a mounting frame and a first movable frame slidably engaged to the mounting frame, such that the first movable frame supports a display. At least one linear actuator engages the first movable frame to raise and lower the first movable frame. The linear actuator is disposed between the first movable frame and the mounting frame. At least a portion of the movable frame configuration may comprise a panel. Ball bearings may be provided between the movable frame configuration and the mounting frame. A motor drives the linear actuator so as to elevate the display to a desired height, and to lower the display. Wherein the at least one linear actuator may comprise a chain, belt, lead screw, ball screw, cable. The at least one linear actuator may also be spring driven, pneumatic, hydraulic, electro-hydraulic, or comprises a rack and pinion.

An exemplary embodiment comprises an elevating apparatus for a visual display comprising a mounting frame; a first movable frame slidably engaged to the mounting frame; and a second movable frame to support a display, the second movable frame being slidably engaged to the first movable frame to provide movable frame configuration. A linear actuator engages the first movable frame so as to raise and lower the first movable frame. At least one pulley is attached to the first movable frame and at least one pliable member engages the at least one pulley, wherein one side of the pliable member is coupled to the mounting frame and another side of the pliable member is coupled with the second movable frame. The movable frame configuration is provided with at least one support member attached to the visual display, the support member being rotatable around at least a portion of the movable frame configuration.

According to another exemplary embodiment, an elevating apparatus is provided comprising a mounting frame; a first movable frame linearly movable within the mounting frame; and a second movable frame to support an object, the second movable frame being slidably engaged along the first movable frame to provide a movable frame configuration. A linear actuator engages the first movable frame so as to raise and lower the first movable frame. At least a first pulley and a second pulley are attached to the first movable frame and at least one pliable member which engages the first pulley and the second pulley, wherein one side of the pliable member is coupled to a lower portion of the mounting frame and another side of the pliable member is coupled with an upper portion of the mounting frame, a portion of the pliable member is non-movably fixed to the second movable frame, such that the second movable frame moves at a greater rate than the first movable frame due to a mechanical advantage provided by the first pulley.

According to an exemplary embodiment, all working parts are fully housed inside the lift's enclosure and not accessible by user. It is further contemplated that the lift doesn't have any horizontally placed parts, which could create a cutting action. These features dramatically decrease the chance of injury by a user or child, while the lift is in action, making the present invention a much safer construction than prior lifts, which did not offer a way of enclosing all working parts.

### BRIEF DESCRIPTION OF THE DRAWINGS

FIG. 1 is top view of a single screw exemplary embodiment;

FIG. 2 is a front view of an exemplary embodiment in a lowered position;

FIG. 3 is front view of an embodiment in an elevated position;

FIG. 4 is front view of an exemplary embodiment in an elevated condition; and

FIG. 5 is front view of an exemplary embodiment in a lowered condition.

FIG. 6 is a front view of an exemplary embodiment;

FIG. 7 is a top view of the embodiment in FIG. 6;

FIG. 8 is a front view of the embodiment in FIG. 7, while being in an extended configuration;

FIG. 9 is a top view of a further exemplary embodiment; and

FIG. 10 is a front view of the embodiment in FIG. 9, while in an extended position.

FIG. 11 is a front view of a further exemplary embodiment;

FIG. 12 is a top view of the embodiment in FIG. 11;

FIG. 13 is a front view of the embodiment in FIG. 11, while being in an extended configuration;

FIG. 14 is a perspective view of a further exemplary embodiment;

FIG. 15 is a top view of the embodiment in FIG. 14;

FIG. 16 is a side view of the embodiment of FIG. 14; and

FIG. 17 is an alternative arrangement of the embodiment depicted in FIG. 14.

### DETAILED DESCRIPTION OF EXEMPLARY EMBODIMENTS

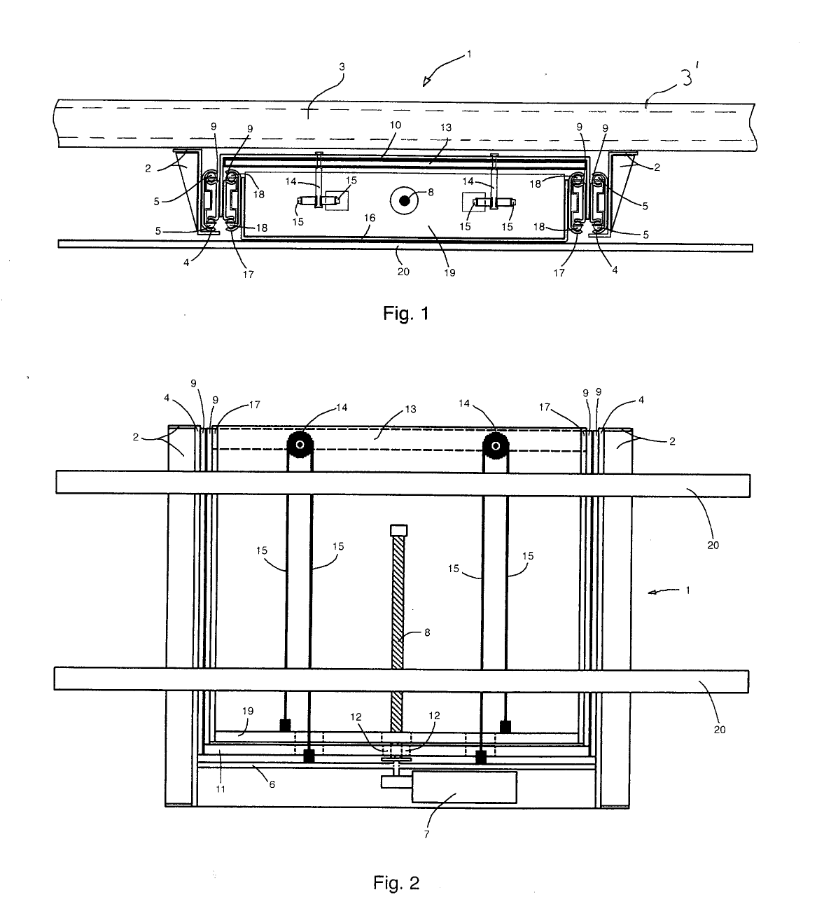

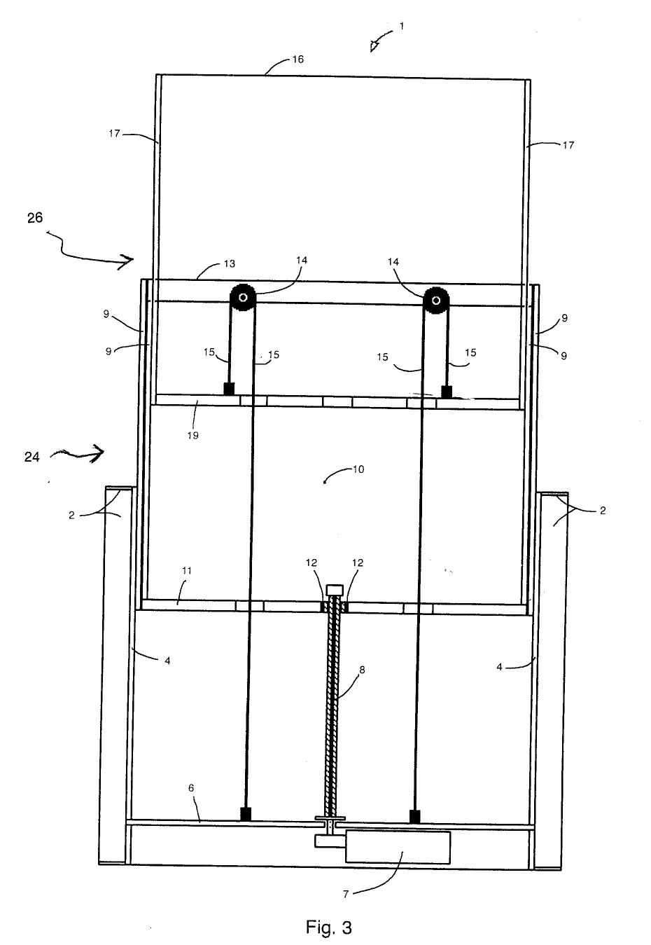

Referring now to the FIGS. 1-3, an elevating apparatus 1 is shown having a pair of lift-mounting brackets 2 mounted to a mounting panel 3, and a pair of outer slide members 4 attached to the lift-mounting brackets 2. A stabilizing bar 3′ may also be added along a top of the mounting panel 3 to aid in resisting bending moments exerted upon the mounting panel 3. A horizontal motor-mount bar 6 is attached to the lift-mounting brackets 2, and a single shaft right angle gear motor 7 is mounted to the motor-mount bar 6. A single vertical threaded rod 8 is mounted to a shaft of gear motor 7. Two pairs of inner slide members 9 are attached to a back panel 10. Ball bearings 5 are disposed between the inner slide members 9 and the lift-mounting brackets 2. A horizontal bar 11 is attached to the back panel 10. A single threaded nut 12 is mounted on the vertical threaded rod 8 and attached to the horizontal bar 11. A sprockets/pulleys-bar 13 is attached to the back panel 10. A pair of sprockets/pulleys 14 is attached to the sprockets/pulleys-bar 13 of the back panel 10. A pair of chains/belts 15 are mounted on the sprockets/pulleys 14 where each is attached to the motor-mount bar 6 at one end and to a horizontal bar 19, attached to the front panel 16 at the other end. A pair of outer slide members 17 is attached to the front panel 16 and ride on ball bearings 18. Two display-supporting bars 20 are mounted to the front panel 16.

In operation, the single shaft gear motor 7 rotates the vertical threaded rod 8. The single threaded nut 12 on the rod 8 is attached to a sliding inner frame 24. The sliding inner frame 24 comprises the back panel 10, the four inner slide members 9, the horizontal bar 11, the sprockets/pulleys-bar 13 and the threaded nut 12. The threaded nut 12 is mounted on the threaded rod 8 and attached to the horizontal bar 11. Rotation of the threaded rod 8 causes the threaded nut 12 and sliding inner frame 24 to rise and fall under control of the motor 7.

An exemplary additional lifting mechanism is provided that includes the two sprockets/pulleys 14 and the two chains/belts 15, which causes a sliding outer frame 26 with the display-supporting bars 20 to elevate or lower to a height above the height of the retracted apparatus for concealment in shorter cabinet. The front panel 16, two outer slide members 17 and the horizontal bar 19 constitute the sliding outer frame 26.

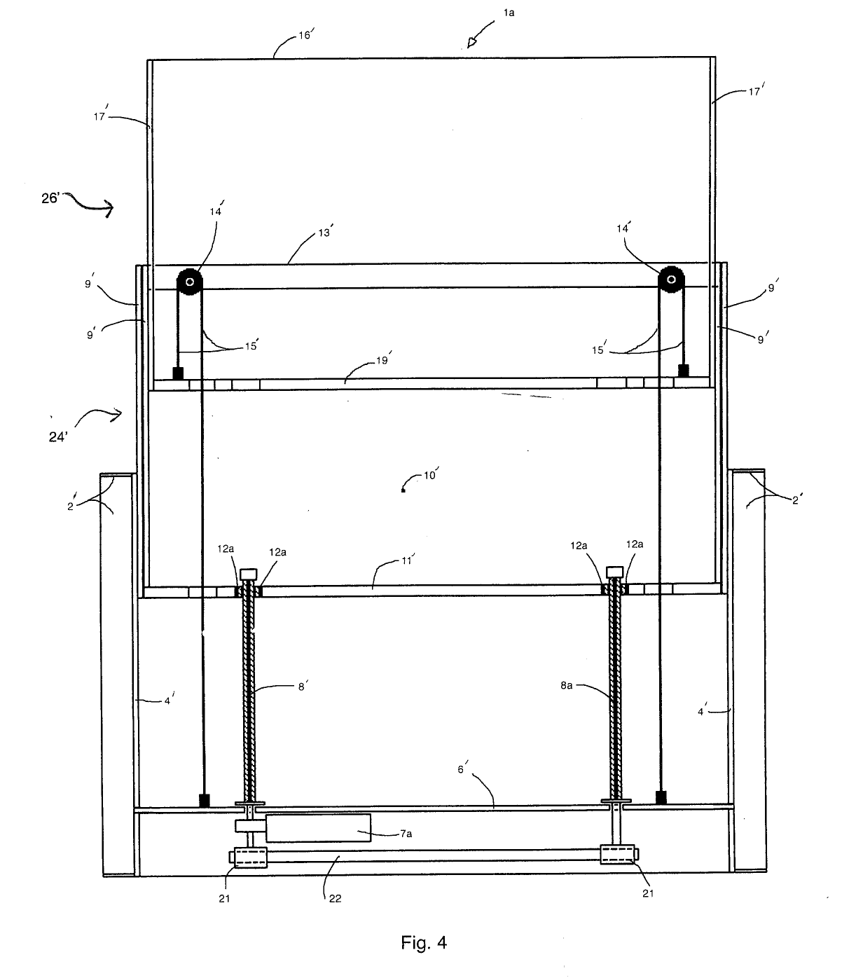

As shown in FIG. 4 an exemplary embodiment further provides for a pair of lift-mounting brackets 2′ to be mounted to a mounting panel 3 (FIG. 1), and a pair of outer slide members 4′ to be attached to the lift mounting brackets 2′. Ball bearings having the same structure as the ball bearings 5 in FIG. 1 are disposed between the inner slide members 9′ and the lift-mounting brackets 2′. A horizontal motor-mount bar 6′ is attached to the lift-mounting brackets 2′, and a double shaft-right angle gear motor 7a is mounted to the motor-mount bar 6′. A vertical threaded rod 8′ is mounted to one end of the double shaft gear motor 7a, and the vertical threaded rod 8a is mounted inside the motor-mount bar 6′. Two pairs of inner slide members 9′ are attached to a back panel 10′. A horizontal bar 11′ is also attached to the back panel 10′. A pair of threaded nuts 12a is mounted on the vertical threaded rods 8′, 8a and are attached to the horizontal bar 11′. A sprockets/pulleys-bar 13′ is attached to the back panel 10′, and a pair of sprockets/pulleys 14′ are attached to sprockets/pulleys-bar 13′. A pair of chains/belts 15′ are mounted on the sprockets/pulleys 14′ and each is attached to the motor-mount bar 6′ at one end and to a horizontal bar 19′ at the other end. A pair of outer slide members 17′ is attached to the front panel 16′ and ride on ball bearings having the same structure as the bearings 18 in FIG. 1. A pair of display-supporting bars 20 (FIG. 2) are to be mounted to the front panel 16′. A pair of sprockets 21 are provide such that one is attached to the shaft of double shaft motor 7a and other is attached to vertical threaded rod 8a. A chain 22 connects the pair of sprockets 21.

In operation, the double shaft gear motor 7a rotates the pair of vertical threaded rods 8′, 8a at the same rate through the set of sprockets 21 and the connecting chain 22. A first sprocket is attached to one end of double shaft gear motor 7a, and a second sprocket is attached directly to the second threaded rod 8a. The two sprockets are connected with the chain 22 to rotate rods in synchrony. The two threaded nuts 12a on the rods 8′, 8a, are attached to a sliding inner frame 24′. The sliding inner frame 24′ comprises the back panel 10′, four inner slide members 9′, the horizontal bar 11′, the sprockets/pulleys-bar 13′ and the two threaded nuts 12a. The threaded nuts 12a are mounted on the threaded rods 8′, 8a and are attached to the horizontal bar 11′. Synchronous rotation of the threaded rods 8′, 8a causes the threaded nuts 12a and the sliding inner frame 24′ to rise and fall under control of the motor 7a.

An exemplary additional lifting mechanism is provided that includes the two sprockets/pulleys 14′ and the two chains/belts 15′ and causes a sliding outer frame 26′ with the display-supporting bars 20 (FIG. 2) to elevate or lower to a height above the height of the retracted apparatus for concealment in shorter cabinet. The sliding outer frame 26′ comprises the front panel 16′, the two outer slide members 17′ and the horizontal bar 19′.

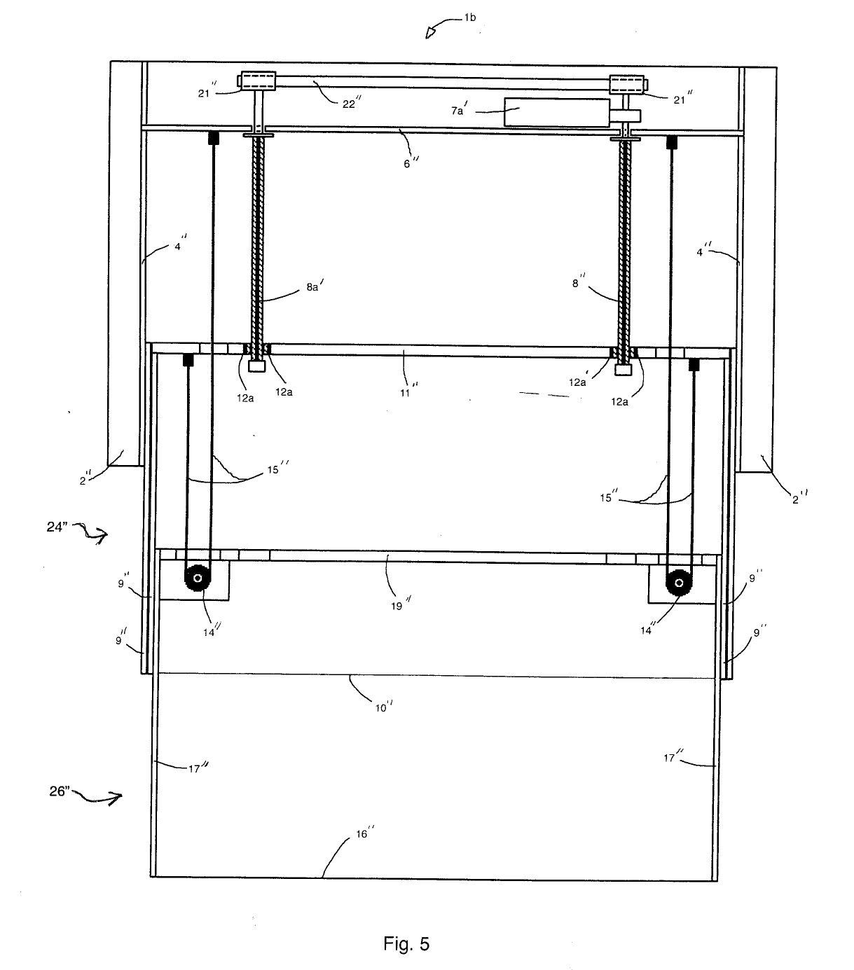

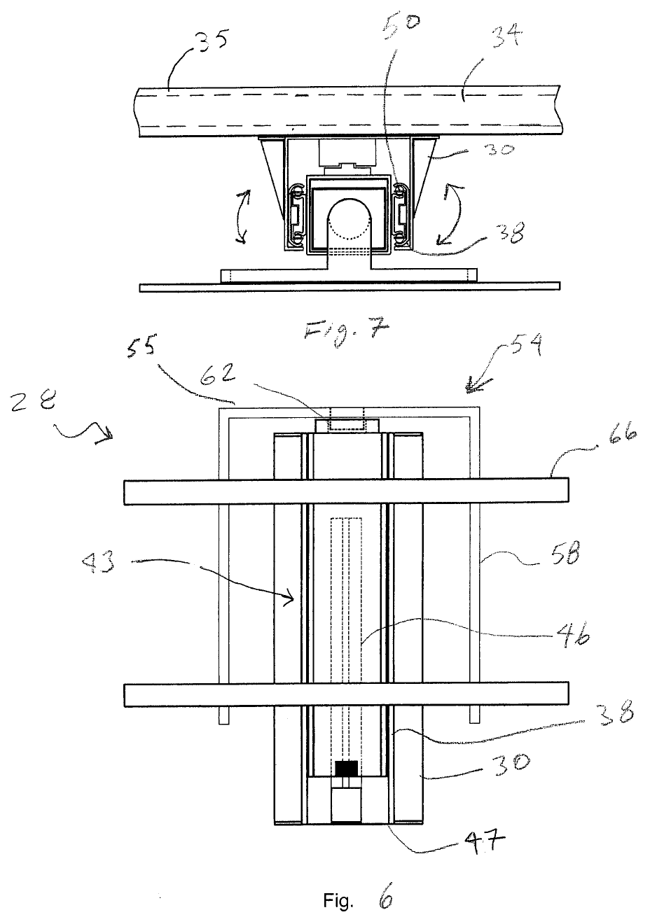

A further exemplary embodiment is shown in FIG. 5 that includes an elevating apparatus 1b. A pair of lift-mounting brackets 2″ are mounted to a mounting panel 3 (FIG. 1), and a pair of outer slide members 4″ are attached to lift mounting brackets 2″. Ball bearings are provided in the same manner as shown in FIG. 1. A horizontal motor-mount bar 6″ is attached to the lift-mounting brackets 2″ and a double shaft-right angle gear motor 7a′ is mounted to the motor-mount bar 6″. A vertical threaded rod 8″ is mounted to one end of the double shaft gear motor 7a′. A vertical threaded rod 8a′ is mounted inside the motor-mount bar 6″. Two pairs of slide members 9″ are attached to a back panel 10″ and a horizontal bar 11″ is also attached to the back panel 10″. A pair of threaded nuts 12a′ are mounted on the threaded rods 8″, 8a′ and attached to the horizontal bar 11″. A pair of sprockets/pulleys 14″ are attached to the front panel 16″ and a pair of chains/belts 15″ are mounted on the sprockets/pulleys 14″ such that the pair of chains/belts 15″ are respectively attached to the motor-mount bar 6″ at one end and to the horizontal bar 11″ at the other end. A pair of outer slide members 17″ is attached to the front panel 16″ and ride on ball bearings, as in FIG. 1. A pair of display-supporting bars 20 (FIG. 2) are to be mounted to the front panel 16″. A pair of sprockets 21″ are provided such that one sprocket is attached to a shaft of the double shaft motor 7a′ and the other is attached to the vertical threaded rod 8a′. A chain 22″ connects the pair of sprockets 21″.

In operation, the double shaft gear motor 7a′ rotates the pair of threaded rods 8″, 8a′ at the same rate through the set of sprockets 21″ and the connecting chain 22″. The first sprocket is attached to one end of the double shaft gear motor 7a, and the second sprocket is attached directly to the second threaded rod 8a′. The two sprockets 21″ are connected with the chain 22″ to rotate the rods 8″, 8a′ in synchrony. The two threaded nuts 12a′ on the rods 8″, 8a′ are attached to a sliding inner frame 24″. The sliding inner frame 24″ comprises the back panel 10″, the four inner slide members 9″, the horizontal bar 11″ and the two threaded nuts 12a′. The threaded nuts 12a′ are mounted on the threaded the rods 8″, 8a′ and are attached to the horizontal bar 11″. Synchronous rotation of the threaded rods 8″, 8a′ causes threaded nuts 12a′ and the sliding inner frame 24″ construction to rise and fall under control of the motor 7a′.

An additional lifting mechanism comprising the two sprockets/pulleys 14″ and the two chains/belts 15″ cause a sliding outer frame 26″ with the display-supporting bars 20, to elevate to a desired height or retract for concealment in a shorter cabinet. The sliding outer frame 26″ comprises the front panel 16″, the two outer slide members 17″ and horizontal bar 19″.

An aspect of the invention is a three-frame system including a frame-within-a-frame design, where two frames slide independently inside of a third one. Moreover, for vertical guides, a combination of ball bearing slides with an open track is used. The frame-within-a-frame construction that uses the open truck slides provides a means to allow an over-extending lift to be attached along its full height.

An exemplary embodiment employs standard industrial, rolled coil steel, and a ball bearing slide, in an open truck design. However, it will be understood that any type of slide or vertical guide with an open track design, which provides ability for a frame-within-frame-construction, could be used. The arrangement or the description of the frames or slides may be changed. Therefore, it will be understood that the invention may be embodied otherwise than as herein specifically illustrated or described and that certain changes in form and arrangement of parts and the specific manner of practicing the invention may be made within the underlying idea or principles of the invention.

In addition, if the lift is used in pairs with a platform attached in between, it could lower large dimensional objects, such as video projectors and regular TV sets.

Referring now to the FIGS. 6-8, a further exemplary embodiment of an elevating apparatus 28 is shown having a pair of lift-mounting brackets or mounting frame 30 mounted to a mounting panel 34, and a pair of slide members 38 attached to the lift-mounting brackets 30 to form a frame on which the slide members 38 are mounted. A stabilizing bar 35 may also be added along a top of the mounting panel 34 to aid in resisting bending moments exerted upon the mounting panel 34. A moveable frame 43 comprises linearly extending side portions 44 that are slidably engaged with the slide members 38. The moveable frame 43 may also include a base portion 45 extending between the side portions 44.

A linear actuator 46 extends from a base portion 47 of the lift-mounting bracket 30 or an area adjacent thereto to a base 48 of the movable frame 43, to elevate an object or display to a desired height and to lower the display. A portion of the linear actuator 46 is fixedly attached to the base portion 48. The linear actuator may comprise, for example, a chain, a belt, a lead screw, a ball screw, a cable, rack and pinion and the like. The linear actuator 46 may also be, for example, spring driven, pneumatic, hydraulic, electro-hydraulic. This linear actuator 45 may also comprise features know in the art to provide a desired lifting force. The base portion 48 is engaged by the linear actuator 46, such that the base portion 48 is raised and lowered in accordance with the type of linear actuator that is chosen for the application. Ball bearings 50 may be disposed between the slide members 38 and the movable frame 43. It will be appreciated that ball bearings are described in regard to various embodiments discussed in the application. However, other suitable means for allowing frames to slide along each other may also be used, such as a surface treatment to reduce friction or other types of friction reducing means, if needed.

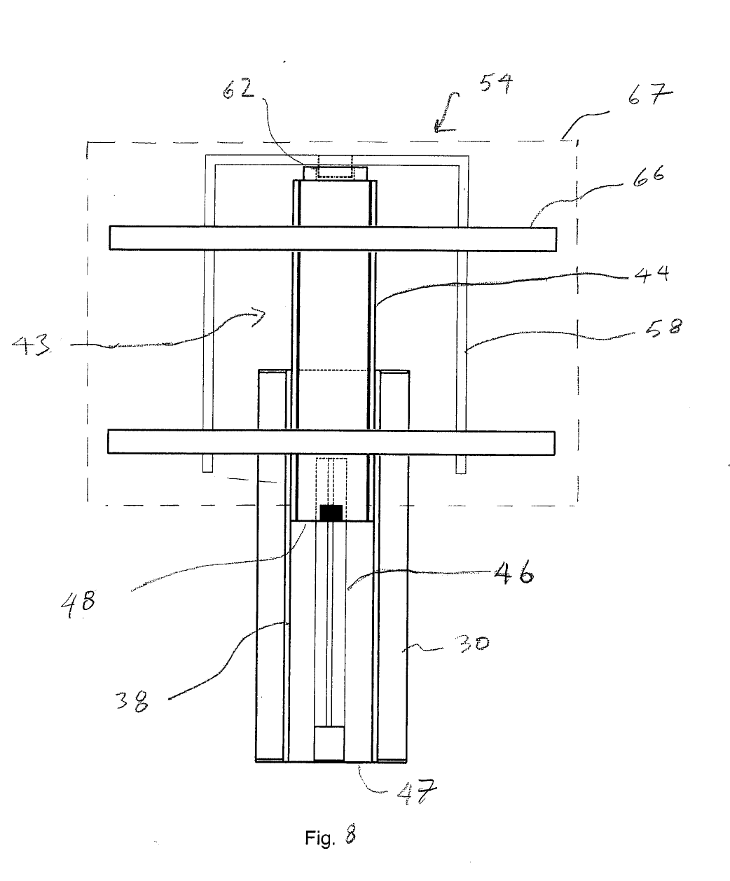

A rotatable support or swivel arm 54 is coupled with the moveable frame 43 via a rotary actuator 62 and is moveable around an axial direction of the lift 28 as represented by the arrows in FIG. 7. The exemplary swivel arm of FIGS. 6-8 includes a cross member 55 having two downwardly extending portions 58. The rotary actuator 62 may be motor driven or configured to be rotatably supported such that when a force is applied to the swivel arm 54 by a user, the swivel arm 54 is moved. Support members 66 may be attached to the swivel arm 54 to support a display. The support members 66 can be disposed in various configurations to provide a mounting area for the display. The exemplary embodiment of FIG. 6 illustrates the support members 66 as extending across the swivel arm 54. It will be appreciated that the number and positioning of support members 66 may change depending on the size and weight of the object or display to be supported. In some cases, a single support member 66 may be sufficient. It is also contemplated that a display may be directly mounted to the swivel arm 54 with an appropriate attachment mechanism.

In operation, the linear actuator 46 exerts a lifting force on the moveable frame 43 so that a user may position the swivel arm 54 at a desired position. The linear actuator 46 is also operable to lower the support area and display. Depending on the type of linear actuator used, the lowering force may be provided by a mechanism of the linear actuator or may be gravity assisted at least in part.

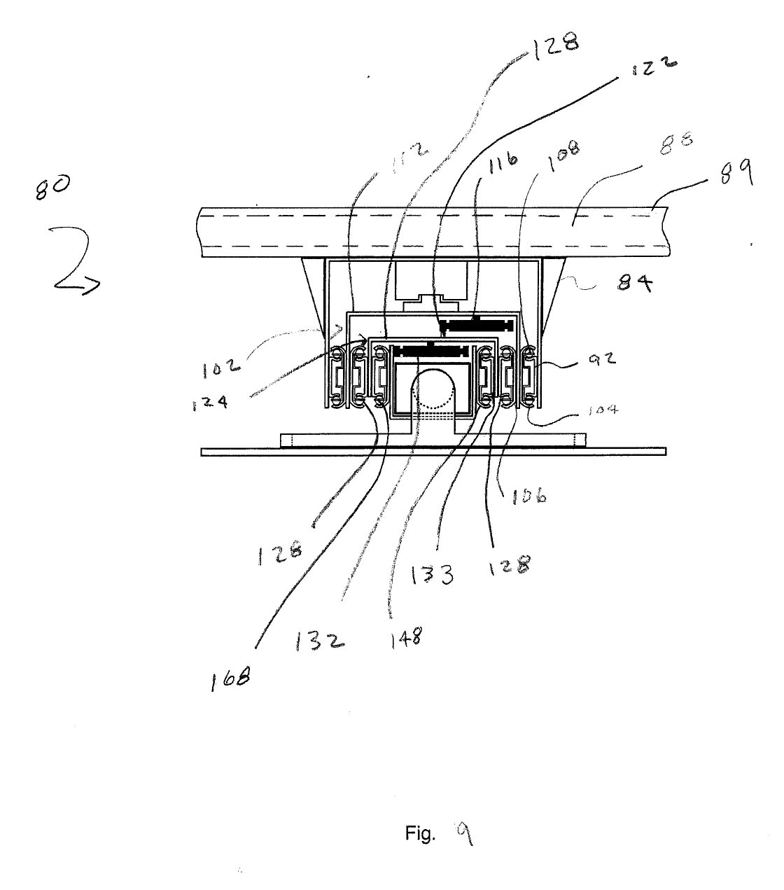

FIG. 8 illustrates an exemplary display 67, such as a flat panel or plasma television mounted on the support members 66. The other exemplary lift embodiments disclosed herein may have a similar type display mounted thereon. It will also be appreciated that all the exemplary embodiments disclosed herein are not limited to use with such visual displays. For example, the exemplary lifting apparatuses disclosed herein could be used as a portable mini crane or extender, which lifts or lower object, such as lights, speakers, studio microphones, antennas, cutters, for example. The exemplary embodiments of the present invention may also be used in an alternative manner, such as for a table leg to provide adjustable height. It will further be appreciated that the uses for the exemplary embodiments disclosed in the present specification are not limited to the above noted purposes and that embodiments consistent with the present invention may be applied in any appropriate circumstance that requires a controlled lifting motion.

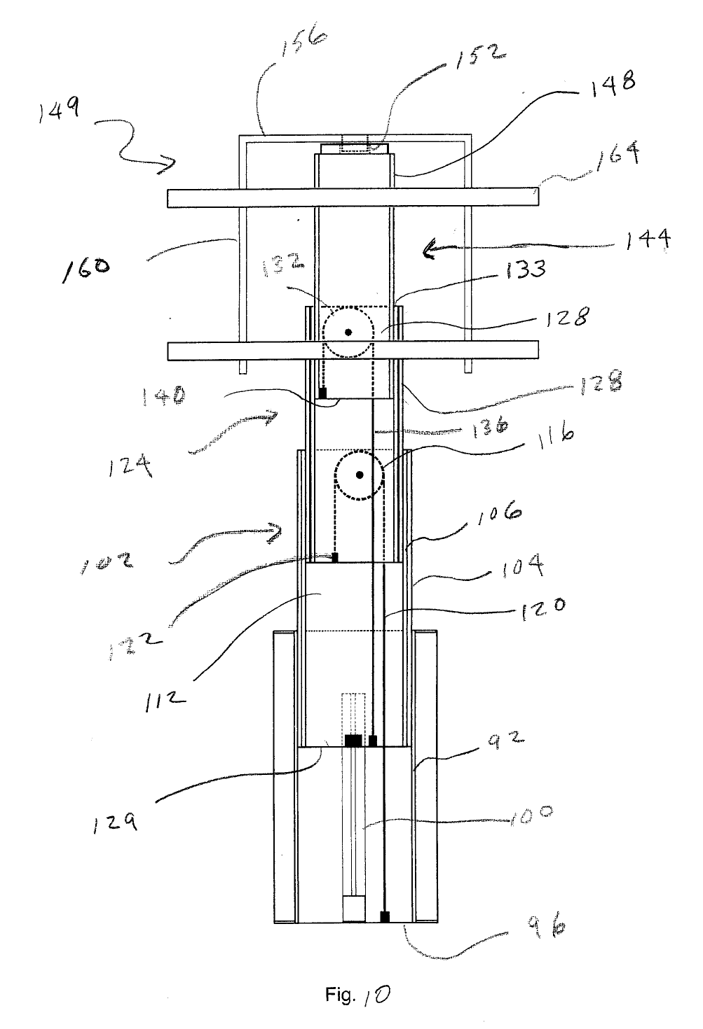

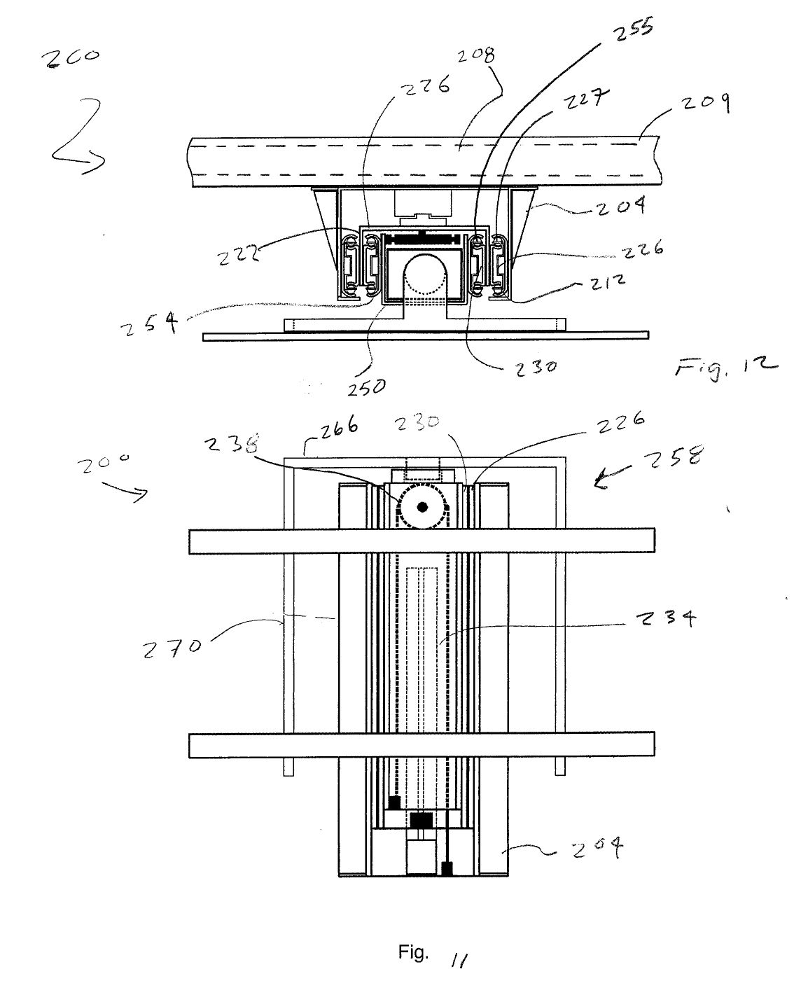

Referring now to the FIGS. 9-10 an exemplary elevating apparatus 80 is shown having a pair of lift-mounting brackets 84 mounted to a mounting panel 88, and a pair of slide support members 92 are attached to the lift-mounting brackets 84 to form a frame. A base member 96 is attached to a lower portion of the lift-mounting brackets 84, and a linear actuator 100 is mounted to, or adjacent, the base member 96. A stabilizing bar 89 may also be added along a top of the mounting panel 88 to aid in resisting bending moments exerted upon the mounting panel 88. The linear actuator 100 may be similar to that described. A first moveable frame 102 is provided comprising first slide members 104 and second slide members 106. The first slide members 104 are slidably engaged with the slide support members 92.

The movable frame 102 includes a support section 112 downwardly extending along a side of the movable frame 102. In an exemplary embodiment, the support section 112 comprises a panel or the like.

Ball bearings 108 are disposed between the slide support members 92 and the first slide members 104, such that the first movable frame 102 is slidably engaged with the slide support members 92. Similar to the embodiment of FIGS. 6-8, the linear actuator 100 extends from the base member 96 to elevate the first moveable frame 102.

A pulley member 116, such as standard sprocket, pulley or the like is attached to the support section 112 of the first movable frame 102. A pliable member 120, such as a chain, belt or the like is mounted on the pulley member 116 and has one end attached to the base member 96 and another end attached to a bottom 122 of a second moveable frame 124. It will be appreciated that more than one pulley member 116 may be used, along with additional pliable members 120.

The second moveable frame 124 comprises third slide members 128 and fourth slide members 132. The third slide members 128 are slidably engaged with the second slide members 106 of the first moveable frame 102. The second movable frame 124 includes a support section 128 downwardly extending along a side of the second movable frame 124. In an exemplary embodiment, the support section 128 comprises a panel or the like.

Ball bearings 128 are disposed between the second slide members 106 and the third slide members 128, such that the second movable frame 124 is slidably engaged with the first moveable frame 102. A pulley member 132 or the like is attached to the support section 128 of the second movable frame 124. A pliable member 136, such as a chain, belt or the like is mounted on the pulley member 132 and has one end attached to a base 129 of the first movable frame 102 and another end attached to a bottom 140 of a third moveable frame 144. Similar to above, it will be appreciated that more than one pulley member may be used, along with additional pliable members.

The third moveable frame 144 comprises fifth slide members 148 that are slidably engaged with the forth slide members 133 of the second moveable frame 124. The third movable frame 144 includes a rotatable support or swivel arm 149 that is coupled with the third moveable frame 144 via a rotary actuator 152 and is moveable around an axial direction of the lift, similar to the embodiments of FIGS. 6-8. The exemplary swivel arm of FIGS. 9 and 10 includes a cross member 156 having two downwardly extending portions 160. The rotary actuator 152 may be motor driven or configured to be rotatably supported such that when a force is applied to the swivel arm 149 by a user, the swivel arm 149 is moved. Support members 164 may be attached to the swivel arm 149 to support a display. The support members 164 can be disposed in various configurations to provide a mounting area for the types of displays or objects described herein. The exemplary embodiment of FIG. 10 illustrates the support members 164 as extending across the swivel arm 148. It will be appreciated that the number and positioning of the support members 164 may change depending on the size and weight of the display to be supported. In some cases, a single support member 164 may be sufficient. It is also contemplated that a display may be directly mounted to the swivel arm 148 with an appropriate attachment mechanism.

Ball bearings 168 are disposed between the fourth second slide members 133 and the fifth slide members 148 that, such that the third movable frame 144 is slidably engaged with the second moveable frame 124. Because the pliable member 136 has one end attached to the bottom 140 of the third moveable frame 144, the third moveable frame 144 is raised in accordance with the mechanical advantage provided by the pulley or sprocket 132 and the pliable member 136.

In operation, the linear actuator 100 exerts a lifting force on the first moveable frame 102, which thereby imparts a lifting motion to the pulley member 116. Because one end of the pliable member 120 is attached to the second movable frame 124, the second movable frame 124 is also lifted along with the pulley member 132. Also, because one end of the pliable member 136 is attached to the third movable frame 144, the third movable frame 144 is lifted. Thus, the configuration of pulleys provides various degrees of mechanical advantage such that the successive movable frames 124 and 144 are each raised at a speed faster than a previous moveable frame.

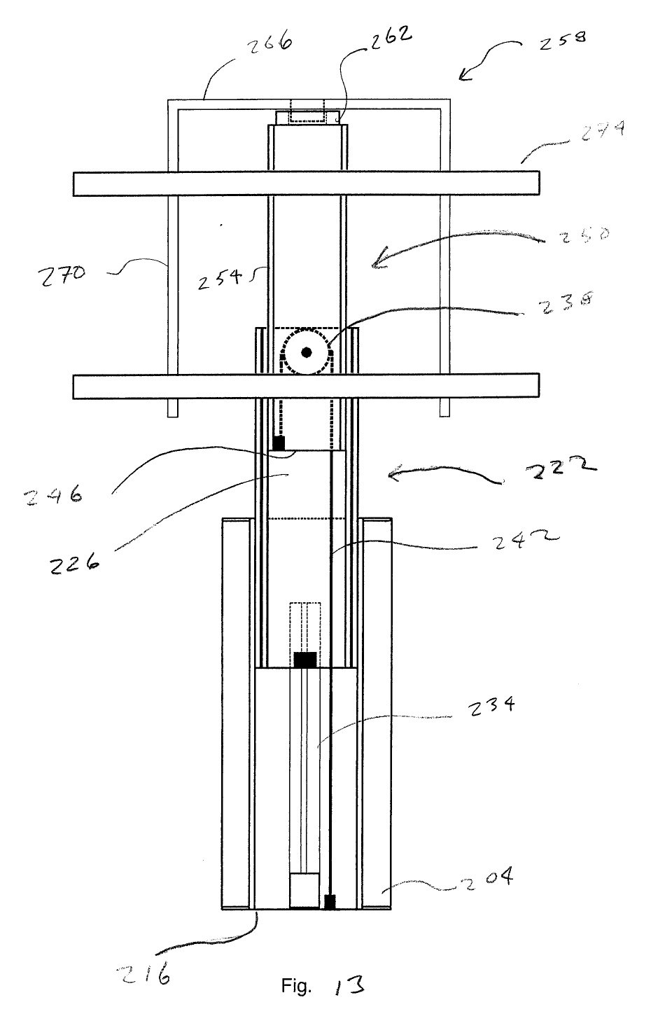

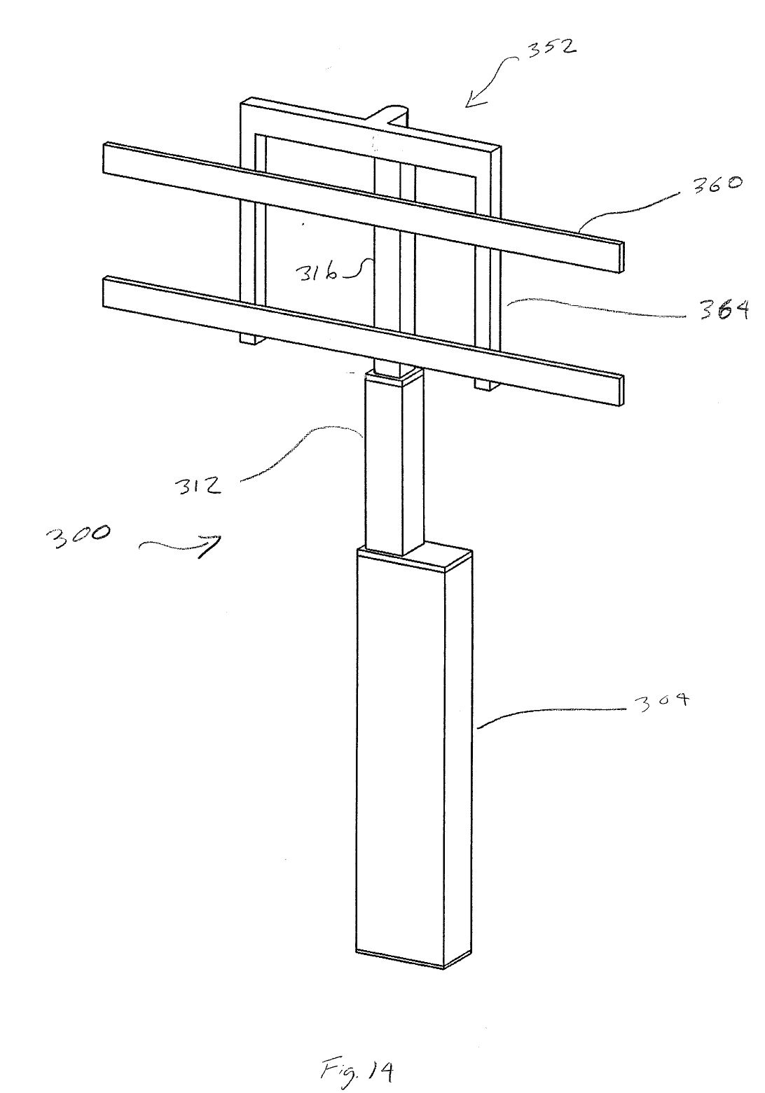

Referring now to the FIGS. 11-13 an exemplary two-stage elevating apparatus 200 is shown having a pair of lift-mounting brackets 204 mounted to a mounting panel 208, and a pair of slide support members 212 are attached to the lift-mounting brackets 204. A stabilizing bar 209 may also be added along a top of the mounting panel 208 to aid in resisting bending moments exerted upon the mounting panel 208. A base member 216 is attached to a lower portion of the lift-mounting brackets 204 to provide a mounting frame, and a linear actuator 218 is mounted to, or adjacent, the support base member 216. The linear actuator 218 may be similar to that described with regard to the above-noted embodiments. A first moveable frame 222 is provided comprising first slide members 226 and second slide members 230. The first slide members 226 are slidably engaged with the slide support members 212.

The first movable frame 222 includes a support section 226 downwardly extending along a side of the movable frame 222. In an exemplary embodiment, the support section 226 comprises a panel or the like.

Ball bearings 227 are disposed between the slide support members 212 and the first slide members 226, such that the first movable frame 222 is slidably engaged with the slide support members 212. A linear actuator 234 extends from the support base member 216 to elevate the first moveable frame 222.

A pulley member 238, such as standard pulley, sprocket or the like is attached to the support section 226 of the first movable frame 222. A pliable member 242, such as a chain, belt or the like is mounted on the pulley member 238 and has one end attached to the support base member 216 and another end attached to a bottom 246 of a second moveable frame 250. It will be appreciated that more than one pulley member 238 may be used, along with additional chains or belts 242.

The second moveable frame 250 comprises third slide members 254 that are slidably engaged with the second slide members 230 of the second moveable frame 250, via bearings 255. The second movable frame 250 includes a rotatable support or swivel arm 258 that is coupled with the second moveable frame 250 via a rotary actuator 262 and is moveable around an axial direction of the lift, similar to the above-noted embodiments. The exemplary swivel arm of FIGS. 11-13 includes a cross member 266 having two downwardly extending portions 270. The rotary actuator 262 may be motor driven or configured to be rotatably supported such that when a force is applied to the swivel arm 258 by a user, the swivel arm 258 is moved. Support members 274 may be attached to the swivel arm 258 to support a display and may be disposed in various configurations, similar to the above-noted exemplary embodiments. The exemplary embodiment of FIG. 11 illustrates the support members 274 as extending across the swivel arm 148. It will be appreciated that the number and positioning of the support members 274 may change depending on the size and weight of the display to be supported. In some cases, a single support member 274 may be sufficient. It is also contemplated that a display may be directly mounted to the swivel arm 148 with an appropriate attachment mechanism.

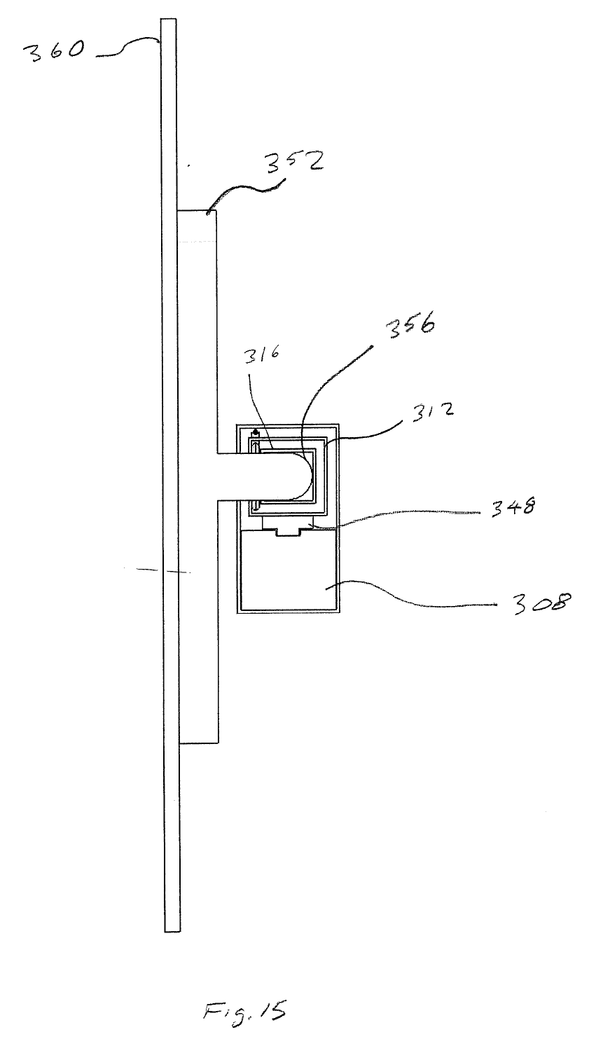

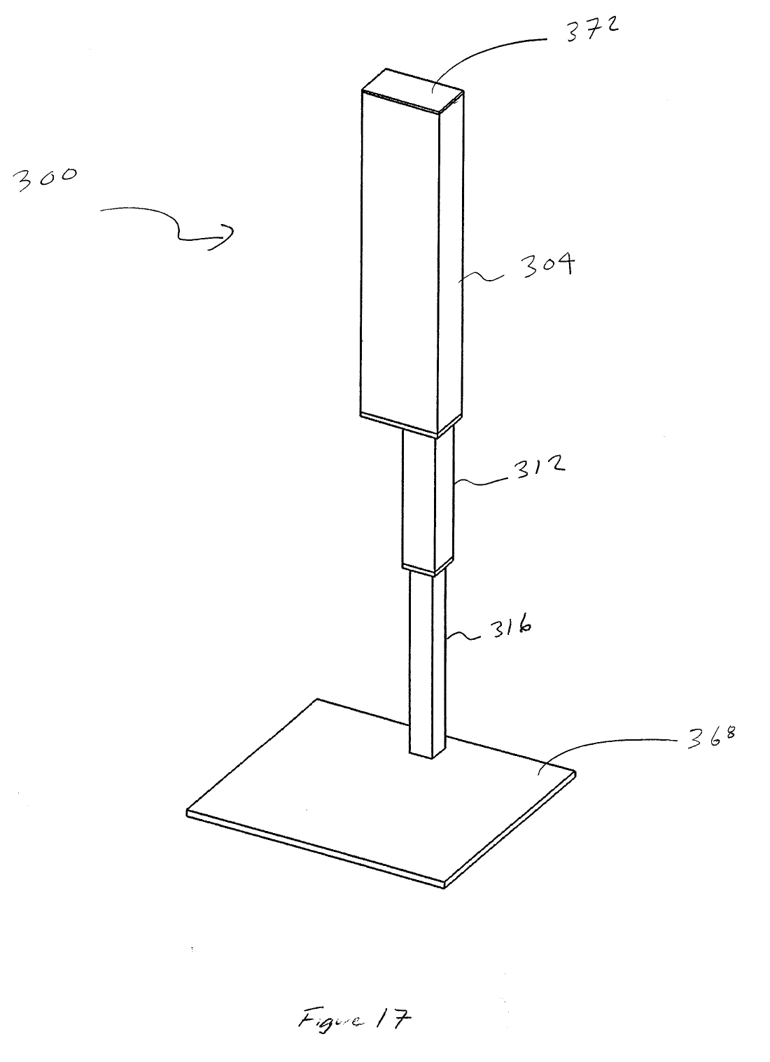

Referring now to the FIGS. 14-16 an exemplary two-stage elevating apparatus 300 is shown having a base or mounting frame 304 for containing a linear actuator 308, a first moveable frame 312 and a second movable frame 316. The linear actuator 308 may be of the type comprising, for example, a chain, a belt, a lead screw, a ball screw, a cable, rack and pinion and the like. The linear actuator 308 may also be, for example, spring driven, pneumatic, hydraulic, electro-hydraulic.

Although not shown, the first movable frame 312 and the second movable frame 316 may be engaged with each other using slide members and bearings as discussed in the above embodiments. Other suitable means of engaging together the first and second movable frames 312 and 316 may also be used to reduce friction and allow the frames to slide along each other. It will be appreciated that the movable frames may also be disposed so that they do not need additional assistance to facilitate to their sliding engagement. Also, if needed, a friction reducing material may be disposed between the movable frames and between the movable frames and mounting frame.

A first pulley 320 is attached to a lower portion of the first moveable frame 312 and another pulley member 324 is attached to an upper portion of the first movable frame 312. The pulley members 320 and 324 may be in the form of a standard pulley or sprocket, or the like, for example. A pliable member 328 is engaged with the pulley members 320 and 324, which may be in the form of a belt or chain, or the like. The pliable member 328 has a first end fixed to a lower area 332 of the base 304 at a first connection point 334 and a second end fixed to an upper area 340 of the base 304 at a second connection point 342. A fastener 344 is attached to the second movable frame 316 for fixedly securing the pliable member 328 to the second moveable frame 316 so it does not move. The pliable member 328 is fixed to the second movable frame 316 at the fastener 344 so that when the pulley member 324 is raised, an upward force is applied to the second moveable frame 316 to raise the second moveable frame 316.

The linear actuator 308 is provided with an attachment piece 348 for mounting the first movable frame 312. The linear actuator 308 is operable to raise and lower the attachment piece 348 and, thus, raise and lower the first movable frame 312. The attachment piece 348 may be connected to the first movable frame 312 by using fastening techniques know in the art.

In operation, the linear actuator 308 raises the attachment piece 348, which in turn raises the first movable frame 312, along with the pulley members 320 and 324 that are attached to the first moveable frame 312. Accordingly, an upward force is applied to the second moveable frame 316 due to the pliable member 328 being attached at the fastener 344.

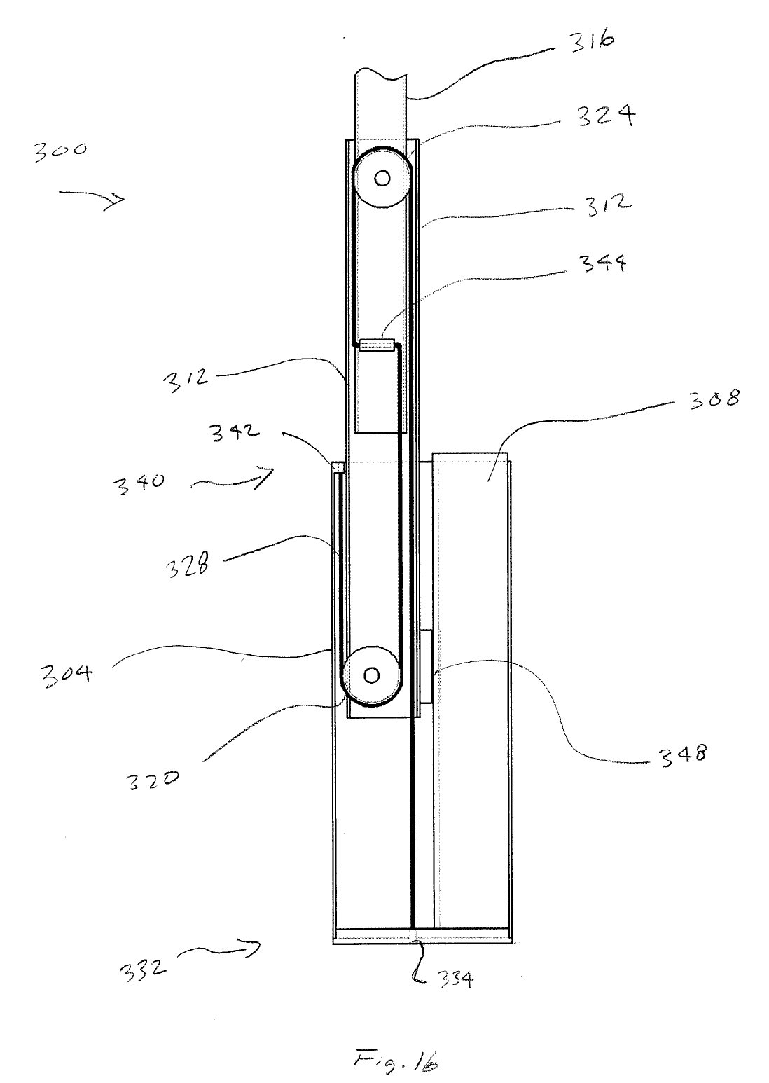

The second movable frame 316 includes a rotatable support or swivel arm 352 that is coupled with the second moveable frame 316 via a rotary actuator 356, which is best seen in FIG. 15. The swivel arm 352 is moveable around an axial direction of the lift, similar to the above-noted embodiments. A cross member 360 is provided that has two downwardly extending portions 364. The rotary actuator 356 may be motor driven or configured to be rotatably supported such that when a force is applied to the swivel arm 352 by a user, the swivel arm 352 is moved. Support members 360 may be attached to the swivel arm 352 to support a display and may be disposed in various configurations, similar to the above-noted exemplary embodiments. It will be appreciated that the configuration of the swivel arm 352 and support members 360 may change depending on the element or object to be supported by the elevating apparatus 300.

The exemplary embodiment of FIGS. 14-16 may also be used in an alternative manner by being mounted to a ceiling or other similar elevated surface. As shown in FIG. 17, the apparatus 300 includes the same features represented in FIGS. 14-16, while substituting a platform 368 for the swivel arm 352. The bottom 372 of the base 304, or an area proximate thereto, is mounted on a ceiling or otherwise elevated surface. Thus, the apparatus 300 is operable to lower and raise a device, such as a display or object, which is attached to the platform 368. It will be appreciated that the rotary actuator 356 and swivel arm 352 in the embodiment of FIGS. 14-16 may be used in the embodiment of FIG. 17 in place of the platform 368. Likewise, the platform 368 of FIG. 17 may be used in place of the rotary actuator 356 and swivel arm 352 in the embodiment of FIGS. 14-16.

In the above-described exemplary embodiments, it will be appreciated that a display or object may be mounted in various configurations, such as to a last moving frame, or to the swivel arm, or to the support members. Also, the platform 368 of FIG. 17 may be rotatable by providing an actuator, or other rotating means, between the platform 368 and the last frame, such as 316.

The previous description of the exemplary embodiments is provided to enable a person skilled in the art to make and use the present invention. Moreover, various modifications to these embodiments will be readily apparent to those skilled in the art, and the generic principles and specific examples defined herein may be applied to other embodiments without the use of inventive faculty. Therefore, the present invention is not intended to be limited to the embodiments described herein, but is to be accorded the widest scope as defined by the limitations of the claims and equivalents thereof.

What is claimed is:

1. An elevating apparatus which lifts an object, said apparatus comprising:
a mounting frame;
a first movable frame slidably engaged to said mounting frame; a second movable frame slidably engaged to said first movable frame; at least a third movable from slidably engaged with said second movable frame, such that a plurality of movable frames are provided;
a last of said plurality of movable frames being configured to support an object,
at least one linear actuator which engages said first movable frame to raise and lower said first movable frame, said linear actuator being disposed between said first movable frame and said mounting frame; and
at least one first pulley attached to said first movable frame and at least one first pliable member which engages said at least one first pulley, a side of said first pliable member is coupled to said mounting frame and another side of said pliable member is coupled with said second frame, such that said second movable frame moves at a greater rate than said first movable frame due to a mechanical advantage provided by said at least one pulley,
at least one second pulley attached to said second movable frame and at least one second pliable member which engages said at least one second pulley, a side of said first pliable member is coupled to said first movable frame and another side of said second pliable member is coupled with said third frame, such that said third frame moves at a greater rate than said second movable frame due to a mechanical advantage provided by said at least one second pulley,
wherein said movable frames are disposed in relation to each other in one of a retracted configuration and an extended configuration, and at least a portion of said second movable frame extends vertically past a portion of said first movable frame, and at least a portion of said third movable frame extends vertically past a portion of said second movable frame in the extended configuration.

2. The elevating apparatus of claim 1, wherein said linear actuator is positioned behind a backside of said object when said elevating apparatus is in the retracted configuration, such that a portion of said linear actuator is disposed at a height equal to a height of a portion of said object in a horizontal plane.

3. The elevating apparatus of claim 1, wherein at least a portion of said plurality of movable frames comprise a panel.

4. The elevating apparatus of claim 1, wherein ball bearings are provided between said first movable frame and said mounting frame.

5. The elevating apparatus of claim 1, wherein said mounting frame includes,
mounting brackets;
slide members respectively attached to said mounting frame;
a motor attached to said linear actuator.

6. The elevating apparatus of claim 1, wherein said plurality of movable frames are provided with at least one support member attached to said object.

7. The elevating apparatus of claim 6, wherein said at least one support member is operable to swivel.

8. The elevating apparatus of claim 7, wherein said support member swivels by means of a rotary actuator.

9. The elevating apparatus of claim 8, wherein said rotary actuator comprises a motor.

10. The elevating apparatus of claim 1, further including a mounting panel attached to said mounting frame.

11. The elevating apparatus of claim 10, wherein said mounting panel comprises a one piece element.

12. The elevating apparatus of claim 1, wherein said elevating apparatus has a front area where said object is located when in the retracted configuration, and said linear actuator is positioned behind said front area, such that a portion of said linear actuator is disposed at a height equal to a height of a portion of said object in a horizontal plane of said elevating apparatus.

13. The elevating apparatus of claim 1, further including at least one motor that drives said at least one linear actuator to elevate said object to a desired height, and to lower said object.

14. The elevating apparatus of claim 1, wherein said at least one linear actuator comprises a chain.

15. The elevating apparatus of claim 1, wherein said at least one linear actuator comprises a belt.

16. The elevating apparatus of claim 1, wherein said at least one linear actuator comprises a lead screw.

17. The elevating apparatus of claim 1, wherein said at least one linear actuator comprises a ball screw.

18. The elevating apparatus of claim 1, wherein said at least one linear actuator comprises a cable.

19. The elevating apparatus of claim 1, wherein said at least one linear actuator is spring driven.

20. The elevating apparatus of claim 1, wherein said at least one linear actuator is pneumatic.

21. The elevating apparatus of claim 1, wherein said at least one linear actuator is hydraulic.

22. The elevating apparatus of claim 1, wherein said at least one linear actuator is electro-hydraulic.

23. The elevating apparatus of claim 1, wherein said at least one linear actuator comprises a rack and pinion.

24. An elevating apparatus which elevates an object, the elevating apparatus comprising:
a mounting frame;
a first movable frame slidably engaged to said mounting frame, said first movable frame supports an object; and
at least one linear actuator which engages said first movable frame to raise and lower said first movable frame, said linear actuator being disposed between said first movable frame and said mounting frame.

25. The elevating apparatus of claim 24, wherein said at least one linear actuator comprises a chain.

26. The elevating apparatus of claim 24, wherein said at least one linear actuator comprises a belt.

27. The elevating apparatus of claim 24, wherein said at least one linear actuator comprises a lead screw.

28. The elevating apparatus of claim 24, wherein said at least one linear actuator comprises a ball screw.

29. The elevating apparatus of claim 24, wherein said at least one linear actuator comprises a cable.

30. The elevating apparatus of claim 24, wherein said at least one linear actuator is spring driven.

31. The elevating apparatus of claim 24, wherein said at least one linear actuator is pneumatic.

32. The elevating apparatus of claim 24, wherein said at least one linear actuator is hydraulic.

33. The elevating apparatus of claim 24, wherein said at least one linear actuator is electro-hydraulic.

34. The elevating apparatus of claim 24, wherein said at least one linear actuator comprises a rack and pinion.

35. The elevating apparatus of claim 24, wherein said linear actuator is positioned behind a backside of said object when said elevating apparatus is in a retracted position, such that a portion of said linear actuator is disposed at a height equal to a height of a portion of said object in a horizontal plane.

36. The elevating apparatus of claim 24, wherein at least a portion of said movable frame configuration includes a panel.

37. The elevating apparatus of claim 24, wherein ball bearings are provided between said movable frame configuration and said mounting frame.

38. The elevating apparatus of claim 24, wherein said mounting frame includes,
mounting brackets;
slide members respectively attached to said mounting frame;
a motor attached to said linear actuator.

39. The elevating apparatus of claim 24, wherein said movable frame configuration is provided with at least one support member to be attached to said object.

40. The elevating apparatus of claim 39, wherein said at least one support member swivels.

41. The elevating apparatus of claim 40, wherein said support member swivels by means of a rotary actuator.

42. The elevating apparatus of claim 41, wherein said rotary actuator comprises a motor.

43. The elevating apparatus of claim 24, further including a mounting panel attached to said mounting frame.

44. The elevating apparatus of claim 43, wherein said mounting panel is a single element.

45. The elevating apparatus of claim 24, wherein said elevating apparatus has a front area where said object is located, and said linear actuator is positioned behind said front area, such that a portion of said linear actuator is disposed at a height equal to a height of a portion of said object in a horizontal plane when said elevating apparatus is in a retracted position.

46. The elevating apparatus of claim 24, further including a motor that drives said linear actuator so as to elevate said object to a desired height, and to lower said object.

47. An elevating apparatus which elevates an object, said apparatus comprising:
a mounting frame;
a first movable frame slidably engaged to said mounting frame;
a second movable frame to support an object, said second movable frame being slidably engaged to said first movable frame to provide a movable frame configuration;
a linear actuator which engages said first movable frame so as to raise and lower said first movable frame; and
at least one pulley attached to said first movable frame and at least one pliable member which engages said at least one pulley, wherein one side of said pliable member is coupled to said mounting frame and another side of said pliable member is coupled with said second movable frame, such that said second movable frame moves at a greater rate than said first movable frame due to a mechanical advantage provided by said at least one pulley;
wherein said movable frame configuration is provided with at least one support member attached to said object, said support member being rotatable around at least a portion of said movable frame configuration.

48. The elevating apparatus of claim 1, wherein said object is an electronic device.

49. The elevating apparatus of claim 48, wherein said electronic device is a flat panel display.

50. The elevating apparatus of claim 24, wherein said object is an electronic device.

51. The elevating apparatus of claim 50, wherein said electronic device is a flat panel display.

52. An elevating apparatus which elevates an object, said apparatus comprising:
a mounting frame;
a first movable frame linearly movable within said mounting frame;
a second movable frame to support an object, said second movable frame being slidably engaged along said first movable frame to provide a movable frame configuration;
a linear actuator which engages said first movable frame so as to raise and lower said first movable frame; and
at least a first pulley and a second pulley attached to said first movable frame and at least one pliable member which engages said first pulley and said second pulley, wherein one side of said pliable member is coupled to a lower portion of said mounting frame and another side of said pliable member is coupled with an upper portion of said mounting frame, a portion of said pliable member is non-movably fixed to said second movable frame, such that said second movable frame moves at a greater rate than said first movable frame due to a mechanical advantage provided by said first pulley.

53. The elevating apparatus of claim 52, wherein said movable frame configuration is provided with at least one support member to be attached to said object.

54. The elevating apparatus of claim 53, wherein said at least one support member swivels.

55. The elevating apparatus of claim 54, wherein said support member swivels by means of a rotary actuator.

56. The elevating apparatus of claim 52, wherein said object is an electronic device.

57. The elevating apparatus of claim 56, wherein said electronic device is a flat panel display.

58. The elevating apparatus of claim 52, wherein said mounting frame is fixed to a ceiling.
